(19) United States
(12) Patent Application Publication
(10) Pub. No.: US 2025/0122123 A1
(43) Pub. Date: Apr. 17, 2025

(54) CEMENT SETTING TIME RETARDER

(71) Applicant: Capital Resin Corporation, Columbus, OH (US)

(72) Inventors: Alicia Doerr, Dublin, OH (US); Thomas Murray, St Louis, MO (US)

(21) Appl. No.: 18/913,699

(22) Filed: Oct. 11, 2024

Related U.S. Application Data
(60) Provisional application No. 63/590,198, filed on Oct. 13, 2023.

(51) Int. Cl. C04B 24/26; C04B 7/02; C04B 103/22

(52) U.S. Cl. CPC C04B 24/2664; C04B 7/02; C04B 24/2641; C04B 2103/22

(57) ABSTRACT

The present invention relates to retardant compositions that include copolymer(s) of carboxylic and/or dicarboxylic monomers, to be mixed with cement ingredients, preferably CSA cement, to form a cement composition that hardens over a longer period of time than traditional CSA cement setting times.

### CROSS-REFERENCE TO RELATED APPLICATIONS

This application is a nonprovisional patent application that makes a priority claim to U.S. Provisional Application No. 63/590,198, filed Oct. 13, 2023, the disclosures of which are hereby incorporated by reference as if fully restated herein.

### TECHNICAL FIELD

The present invention relates generally to chemical polymers and more particularly to polymers useful in retarding the setting time (or curing time) of cement once poured.

### BACKGROUND

Cements are widely used as binding agents for various types of aggregate. Common applications include using cement to bind fine aggregate to produce mortar or to bind sand and gravel to produce concrete.

Cements can be hydraulic or non-hydraulic depending on its characteristics in the presence of water. Hydraulic cements will set and become adhesive through a chemical reaction between its dry ingredients and water whereas non-hydraulic cements will not. Hydraulic cements are much more common that non-hydraulic cements. The use of hydraulic cements generally entails starting with a clinker (i.e., a solid intermediary material produced by sintering limestone and aluminosilicate materials such as clay), grinding that clinker into a powder, and mixing that powder with water.

Ordinary Portland cement (OPC) is a variety of hydraulic cement and is the most common type of cement in general use around the world. Ordinary Portland cement is generally made from clinker produced by heating limestone and clay. The clinker typically includes the calcium silicates alite (Ca₃SiO₅) and belite (Ca₂SiO₄), along with tricalcium aluminate (Ca₃Al₂O₆) and calcium aluminoferrite (Ca₂(Al,Fe)₂O₅).

Skilled artisans will appreciate that ordinary Portland cement is known to have several undesirable qualities, namely, the considerable amount of carbon dioxide emissions released during its manufacture and the high input costs involved (both in terms of raw material requirements and energy requirements for heating the raw material).

Calcium sulfoaluminate (CSA) cement, which contains calcium sulfoaluminate (C₄A₃S) as its primary phase, is another variety of hydraulic cement that has garnered interest as an alternative for Portland cement. CSA cements are considered more environmentally friendly than Portland cements due to releasing less carbon dioxide emissions. However, CSA cements can sometimes be challenging to use due to its rapid setting times. Some CSA cements can set in as fast as 5 minutes to 15 minutes, making it very difficult to work with once poured.

The setting time of hydraulic cements refers to the period during which cement transitions from a fluid or plastic state to a solid state after mixing with water. Setting time is crucial because it determines how quickly cement can begin to harden and achieve strength. Setting time is sometimes classified into two stages-first, an initial setting time during which the cement starts to lose its plasticity and begins to harden, marking the point when the cement can no longer be molded or worked with; and second, a final setting time when the cement has completely lost its plasticity and has hardened to the point where it can support some load, signifying the end of the setting process.

The initial setting time of a cement is a major factor in the overall workability of that cement. It is desirable, if not necessary, for the initial setting time to be long enough to allow for the mixing, transporting, placing, and finishing of the cement without it hardening too quickly.

There exists a need to retard (i.e., slow or delay) the setting time of cements, including CSA cements, so that easier working conditions are available. It is particularly desirable to retard the setting time of cements, including CSA cements, to about an hour or more.

### SUMMARY OF THE INVENTION

The present invention comprises a class of polymers to be added to cement, which slow the setting time of cement (e.g., to retard the formation of ettringite without impairing the development of compressive strength). The polymer(s) of the present invention have never before been known to be useful in combination with cement to slow the setting time of the cement. The preferred polymer(s) are of the class of anionic polymers comprised of dicarboxylic acids.

One aspect of the present invention relates to retardant compositions for retarding the setting time of cement. These retardant compositions include a quantity of a copolymer characterized by at least two monomer species (repeat units), wherein each monomer includes at least one pendant carboxyl group.

Another aspect of the present invention relates to cement compositions that incorporate the aforementioned retardant compositions. These cement compositions include a hydraulic cement clinker, which may be ground or unground, and a quantity of the retardant compositions. The clinker may be Portland cement clinker (of any variety, including ordinary Portland cement) or CSA cement clinker.

Yet another aspect of the present invention relates to a method for retarding cement. The method generally includes the steps of: (a) providing a cement composition comprising a quantity of ground or unground hydraulic cement clinker; (b) providing a quantity of retardant composition as described herein; (c) providing a quantity of water; (d) optionally providing a quantity of one or more additives; and (e) mixing together the cement composition, the quantity of retardant composition, the quantity of water, and, if applicable, the quantity of additive(s).

Other examples of the disclosed retardant composition, cement composition, and method will become apparent from the following detailed description, the accompanying drawings and the appended claims.

### DETAILED DESCRIPTION OF THE INVENTION

As used herein, the term “carboxylic acids” refers to organic acids having at least one carboxyl group; the term is intended to be inclusive of dicarboxylic acids and polycarboxylic acids.

Skilled artisans will appreciate that carboxylic acids, especially dicarboxylic acids, can be dehydrated to form acid anhydrides. For the purposes of the present application, anhydrous forms of carboxylic acids are considered “derivatives” thereof. For example, maleic anhydride would be considered a derivative of maleic acid.

Skilled artisans will also appreciate that polymers having carboxylic repeat units, especially dicarboxylic repeat units, can be partially or fully dehydrated so that some or all of the carboxylic repeat units, respectively, form anhydride functional groups (—C(═O)—O—C(═O)—). For the purposes of the present application, such partially or fully dehydrated polymers are considered “derivatives” of those polymers' fully hydrolyzed acid form.

For the purposes of the present application, salts of carboxylic acids and the polymers synthesized therefrom are also considered “derivatives” thereof.

Free radical polymerization of two or more species of unsaturated carboxylic acids (and/or derivatives thereof) can produce copolymers having multiple pendant carboxyl groups. However, depending on monomer selection these copolymers can consist mostly, if not entirely, of repeat units that each have at least one pendant carboxyl group. These copolymers tend to be highly reactive and readily crosslinkable. Specific examples of such copolymers are described in greater detail below. Broadly described, the present invention relates to the utilization of these copolymers as retarding agents for cement. Some aspects of the present invention include retardant compositions incorporating said copolymers and cement compositions incorporating said retardant compositions.

Maleic-Itaconic Polymers (MIP), which are copolymers formed from maleic acid (or its derivatives) and itaconic acid (or its derivatives), are one type of copolymer that may be suitable for use as a cement retarding agent. Both maleic acid and itaconic acid are unsaturated dicarboxylic acids. MIPs tend to be water-soluble which makes them useful in applications where interaction with aqueous environments is required. MIPs also generally have good thermal stability which makes them suitable for applications that involve heat or require resistance to degradation at elevated temperatures.

MIPs can generally be characterized by the presence of two types of moieties (repeat units) referred to herein as “Group B moieties” and “Group C moieties”.

Group B moieties are moieties according to the generalized formulas:

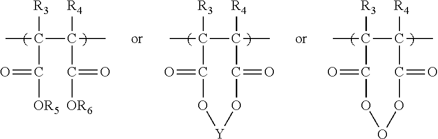

Group C moieties are moieties according to the generalized formulas:

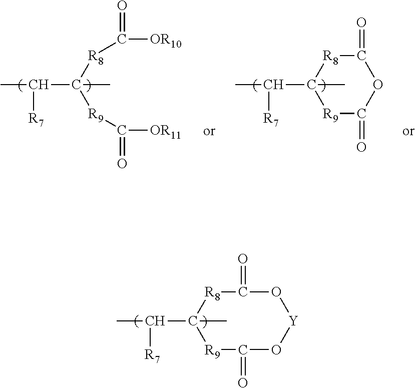

With respect to the Group B and C moieties:
each R₃ and R₄ are individually and respectively selected from the group consisting of H, C₁-C₃₀ straight, branched chain and cyclic alkyl or aryl groups;
each R₅, R₆, R₁₀ and R₁₁ are individually and respectively selected from the group consisting of H, the alkali metals, NH₄ and the C₁-C₄ alkyl ammonium groups;
each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc. up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups;
each R₈ and R₉ are individually and respectively selected from the group consisting of nothing (i.e., the groups are non-existent), CH₂, C₂H₄, and C₃H₆, each of said moieties having or being modified to have a total of two COO groups therein; and
each Y is an ion complexed to the copolymer and may include ions such as, but not limited to, Fe, Mn, Mg, Zn, Cu, Ni, Co, Mo, V and Ca.

Depending on how polymerization is performed, MIPs can vary widely in molecular weight, ranging for example from about 500 Da to about 5,000,000 Da. For the purposes of the present invention, MIPs with molecular weights ranging from about 500 Da to about 20,000 Da are preferred, or more preferably ranging from about 1,000 to about 6,000 Da.

If desired, MIPs can be complexed with metal or non-metal ions using a suitable method. Skilled artisans will appreciate that there are many methods for doing so already known in the art. Examples of specific ions which may be desirable for purposes of the present invention include, but are not limited to, Fe, Mn, Mg, Zn, Cu, Ni, Co, Mo, V, Cr, Si, B, and Ca.

Compatible solvent systems for the polymerization of MIPs can include aqueous or non-aqueous solvents such as ketones, alcohols, esters, ethers, aromatic solvents, water and mixtures thereof. Water alone and the lower (C1-C4) ketones and alcohols are especially preferred, and these may be mixed with water if appropriate.

Free radical polymerization of maleic acid and itaconic acid, and/or derivatives thereof, can be initiated using any suitable free radical initiator or method of initiating. For example, free radical initiators such as peroxides, hydroperoxides, azo initiators, persulfates, percarbonates, per-acids, and charge transfer complexes may be used. Additionally or alternatively, the free radical polymerization may be initiated via irradiation (e.g., UV, electron beam, X-ray, gamma-radiation and other ionizing radiation types).

In some instances, the free radical polymerization of maleic acid and itaconic acid, and/or derivatives thereof, can be carried out with the substantial exclusion of oxygen, typically under an inert gas such as nitrogen or argon.

The initial polymerization step for MIPs can be carried out at temperatures ranging from about 0° C. to about 120° C. for periods of time ranging from about 0.25 hours to about 24 hours. It is preferred, however, that the initial polymerization step be carried out at temperatures ranging from about 30° C. to about 95° C. for a period of time ranging from about 0.25 hours to about 5 hours.

Shown below is a schematic representation of a first possible route for synthesizing MIPs.

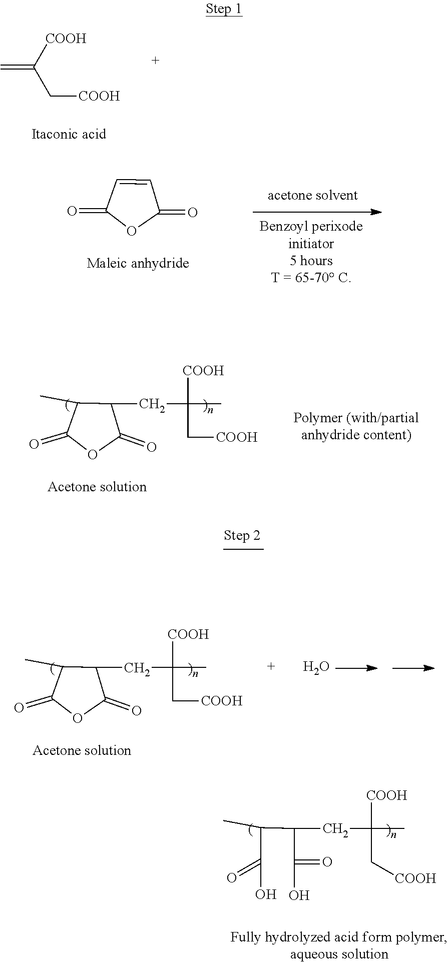

In the presence of a free radical initiator (benxoyl peroxide), itaconic acid and maleic anhydride can copolymerize along their respective alkenes resulting in a copolymer with pendant anhydride and carboxyl groups. The pendant anhydride groups can be converted to carboxyl groups via the addition of water.

Shown below is a second schematic representation of a second possible route for synthesizing MIPs.

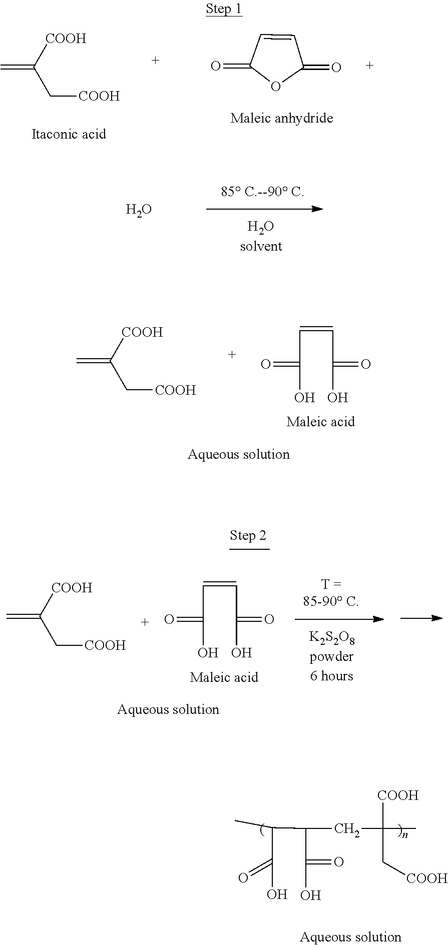

Maleic anhydride can be converted to maleic acid in the presence of water at elevated temperatures. From there, a free radical initiator (potassium persulfate) can be added to initiate the free radical polymerization reaction, resulting in the formation of MIPs with little to no anhydride content.

Shown below is a generalized formula representing a preferred MIPs for use with the present invention. R₃, R₄, R₈, and R₉ are as described above with respect to the Group B and C moieties, and n, m, and p are any integer 1 or greater.

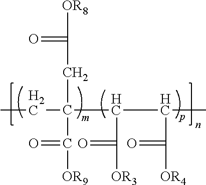

With respect to the present invention, it is noted that MIPs are not the only type of copolymer as described above (i.e., wherein most, if not all, repeat units include at least one pendant carboxyl group) that may be used as a cement retarding agent. Another type of copolymer that may be suitable includes copolymers formed using acrylic acid (an unsaturated monocarboxylic acid) (or its derivatives) as a monomer species. For example, acrylic acid (or its derivatives) can be copolymerized with maleic acid (or its derivatives) and itaconic acid (or its derivatives) to produce terpolymers. In another example, acrylic acid (or its derivatives) can serve as a replacement for maleic acid or itaconic acid, thereby producing either maleic-acrylic copolymers or acrylic-itaconic copolymers, respectively. Synthesis of copolymers using acrylic acid can be carried out using generally the same synthesis routes, reactants (e.g., solvents and free radical initiators), and reaction conditions described above for the synthesis of MIPs.

Retardant compositions according to the present invention include a quantity of a copolymer wherein most, if not all, of its repeat units include at least one pendant carboxyl group. Preferred copolymers include MIPs and acrylic-based copolymers such as those described above, though embodiments of the retardant composition are not limited to such. The copolymers selected for this purpose can be provided in a solid or liquid phase, preferably as a dry powder or particulate.

Some embodiments of the retardant composition will only include the quantity of copolymer as its sole ingredient. Other embodiments of the retardant composition may include other additives as well.

Cement compositions according to the present invention can be prepared by combining a quantity of hydraulic cement clinker, a quantity of retardant compositions as described herein, and optionally other additives as well (e.g., fly ash, slag, silica fume, and gypsum).

The retardant compositions described herein may be combined with a quantity of hydraulic cement clinker and optionally other additives to form a cement composition.

Cement composition according to the present invention will include a quantity of hydraulic cement clinker, which can be ground or unground, and a quantity of retardant composition. The cement clinker can be any suitable clinker such as, but not limited to, ordinary Portland cement clinker and/or CSA cement clinker. The retardant composition can be any of the retardant compositions described above.

The retardant composition can be provided in the cement composition as a solid (preferably as a dry powder) in an amount ranging from about 0.025% to about 10.0% by weight, preferably from about 0.05% to about 5.0% by weight, with respect to the weight of the cement clinker.

Another aspect of the present invention relates to a method of retarding (i.e., delaying or slowing) the setting time of cement. The method generally entails the steps of: (a) providing a cement composition comprising a quantity of ground or unground hydraulic cement clinker; (b) providing a quantity of retardant composition as described herein; (c) providing a quantity of water; (d) optionally providing a quantity of one or more additives; and (e) mixing together the cement composition, the quantity of retardant composition, the quantity of water, and, if applicable, the quantity of additive(s). Any suitable order of mixing may be utilized in the performance of this method. For example, the retardant compositions may be added to cement clinker either before or after it has been ground into a powder. Further, the retardant compositions may be mixed with water and then added to cement or added to cement before the water is mixed in. Variations such as these do not represent a departure from the scope of the present invention.

Any suitable equipment may be utilized to mix retardant composition, cement composition, water, and/or additives. For example, it is contemplated that stand-alone mixers or transit mixers (i.e., concrete/agitator trucks) may be used.

In a first example, which was intended to serve as a control, 200 grams of a CSA cement composition (obtained from Buzzi Unicem USA of Bethlehem, PA) was mixed with 70 grams of water. The resultant mixture was poured and allowed to dry. The set time for that mixture was determined to be approximately 5 minutes.

In a second example, 200 grams of a CSA cement composition (obtained from Buzzi Unicem USA of Bethlehem, PA) was mixed with 70 grams of water and maleic-itaconic polymer at 1% by weight of the CSA cement. The resultant mixture was poured and allowed to dry. The set time for that mixture was determined to be approximately 115 minutes (±4 minutes).

In a third example, 200 grams of a CSA cement composition (obtained from Buzzi Unicem USA of Bethlehem, PA) was mixed with 70 grams of water and maleic-acrylic polymer at 1% by weight of the CSA cement. The resultant mixture was poured and allowed to dry. The set time for that mixture was determined to be approximately 90 minutes.

From a comparison of the first, second, and third examples, it can be observed that the addition of maleic-itaconic polymer at 1% by weight was able to retard the set time of CSA cement by approximately 110 minutes and the addition of maleic-acrylic polymer at 1% by weight was able to retard the set time of CSA cement by approximately 85 minutes. These results represent a dramatic and unexpected improvement in the workability of CSA cement, thereby improving its viability as an alternative for ordinary Portland cement.

What is claimed is:

1. A retardant composition for retarding the setting time of cement, the composition comprising:
a copolymer, or a derivative thereof, defined by at least two different repeat units, wherein each repeat unit comprises at least one pendant carboxyl group.

2. The retardant composition of claim 1, wherein:
the at least two different repeat units comprises maleic acid or a derivative thereof.

3. The retardant composition of claim 2, wherein:
the at least two different repeat units comprise itaconic acid or a derivative thereof.

4. The retardant composition of claim 2, wherein:
the at least two different repeat units comprise acrylic acid or a derivative thereof.

5. A cement composition comprising:
a quantity of the retardant composition of claim 1; and
a quantity of a hydraulic cement clinker.

6. The cement composition of claim 5, wherein:
the hydraulic cement clinker comprises at least one of a Portland cement clinker and a calcium sulfoaluminate (CSA) cement clinker.

7. The cement composition of claim 5, wherein:
the hydraulic cement clinker is ground hydraulic cement clinker provided as a dry powder or particulate.

8. A method for retarding the setting time of cement, the method comprising the steps of:
(a) providing a cement composition comprising a quantity of hydraulic cement clinker;
(b) providing a quantity of the retardant composition of claim 1;
(c) providing a quantity of water;
(d) optionally providing a quantity of one or more additives; and
(e) mixing together the cement composition, the quantity of retardant composition, the quantity of water, and, if applicable, the quantity of additive(s).

9. A cement composition comprising a setting time retarder polymer having recurring polymeric subunits made of carboxylic or dicarboxylic monomers.

10. A method of retarding the setting time of cement, the method comprising:
adding a curing retardant polymer comprised of carboxylic or dicarboxylic monomers to cement.

11. The invention of claim 9 or 10, wherein the cement is CSA cement.
